(19) United States
(12) Patent Application Publication
(10) Pub. No.: US 2002/0068262 A1
(43) Pub. Date: Jun. 6, 2002

(54) Method and apparatus for floral arrangement

(76) Inventor: Dorothy Mavis Robinson, Surrey (GB)

Correspondence Address: FINNEGAN, HENDERSON, FARABOW, GARRETT &, DUNNER LLP, 1300 I STREET, NW, WASHINGTON, DC, 20005, US

(21) Appl. No.: 09/730,843

(22) Filed: Dec. 7, 2000

(30) Foreign Application Priority Data
Dec. 5, 2000 (GB) 0029633.5

(51) Int. Cl. G09B 25/08

(52) U.S. Cl. 434/93

(57) ABSTRACT

The present invention provides a method of teaching a trainee how to arrange flowers by presenting them with representations of the arrangement to be produced in which flowers are represented by sticks or the like.

### BACKGROUND OF THE INVENTION

The present invention relates to the arrangement of flowers and floral displays and more specifically to a method and apparatus for teaching people how to prepare such arrangements.

The preparation of floral displays is a highly skilled task and learning how to prepare and arrange flowers to provide an interesting and pleasing display requires experience and training. There are many factors which affect the placement and choice of a specific flower to achieve an overall effect in the finished arrangement. These factors include type and length of flower, preparation of the flower prior to insertion in the arrangement, the position at which the flower is inserted and the angle of insertion and so on.

Flower arrangements are typically prepared around a central support structure which may be formed from chicken wire arranged into a three dimensional shape or using crushable foam material known as florist's foam, e.g. Oasis™. Either of these types of structure allow flowers to be inserted at almost any position and angle and held securely in that position. This provides great flexibility to the designer of arrangements in terms of the positioning of flowers. However, this kind of structure has a problem when trying to train a student in the art of arranging.

When teaching a student how to prepare an arrangement, it is relatively straightforward to explain and demonstrate how to select and prepare a flower. However, it is also important for students to be able to see the positioning and angling of the flower as it is inserted into the support structure. Whilst this is relatively easy to do for the first few flowers because the support structure is plainly visible, as more and more flowers are inserted, the support structure becomes obscured by the parts, i.e. stems, foliage and heads, of the flowers. Thus it becomes difficult for students to see clearly where the flower is being inserted and also at what angle the flower is being inserted.

In a classroom environment the student can examine the arrangement up close and from many different angles. They can also improve their view by moving aside foliage which is obscuring their view of the support structure. Even so, it can still be hard to get a clear picture of the precise location and angle of insertion of a stem, especially when there are already a number of stems in place. The situation is even more difficult where the student cannot directly view the arrangement up close. For example, where a student is learning the art of flower arranging from a book or from a presentation using pictures rather than by viewing real flowers, the ability to examine the arrangement closely is not available. Even if many pictures from many different angles are provided, it is difficult to appreciate clearly the information regarding angle and position that the student needs in order to learn.

### SUMMARY OF THE INVENTION

Therefore according to the present invention there is provided a method of trainer teaching a trainee how to produce a flower arrangement comprising inserting one or more sticks into a support structure at predetermined locations, each stick corresponding to the location and angle of insertion of a flower of the flower arrangement

The present invention also provides a method of training a trainee how to produce a flower arrangement comprising presenting to the trainee a series of image sets, each image set comprising one or more images representing a stage in the process of preparing the flower arrangement, the images including one or more sticks positioned and arranged at angles corresponding to a flower in the flower arrangement.

The present invention also provides a kit of parts for use in teaching trainees how to produce a flower arrangement, the kit comprising at least one support structure into which a plurality of sticks can be inserted and retained at a variety of mutual angles and insertion depths, and a plurality of generally elongate sticks for representing flowers in an arrangement, the sticks being substantially free of protuberances such the view of the support structure and the position and angle at which the sticks had previously been inserted into the block is not obscured.

The present invention also provides a system for generating images to assist in developing a flower arrangement as claimed in claim 12.

The present invention further provides a device for generating images representing a flower arrangement, for display on a display device, the device comprising: a controller arranged to generate one or more first images, each image showing a symbolic representation of a flower arrangement comprising a support structure and one or more generally elongate objects representing each flower, each object being devoid of foliage at least at one end.

The present invention further provides a computerised teaching aid for teaching a trainee to produce a flower arrangement, comprising:

storage means for storing data on one or more flower arrangements and data on generally elongate objects corresponding to flowers and/or foliage used in the or each flower arrangement; and

a user interface for generating and outputting images of the or each flower arrangement and images of the generally elongate objects positioned in a support structure in positions corresponding to the positions of corresponding flowers and/or foliage in the or each flower arrangement.

The present invention can be implemented on a single apparatus or on a client apparatus and a server apparatus each comprising a suitably programmed general purpose computer. Thus the present invention can be embodied as computer programme code for controlling a general purpose computer. The computer programme code can be provided to a general purpose computer on any suitable carrier medium such as a storage medium (e.g. floppy disk drive, CD ROM, magnetic tape or programmable memory device) or a signal (such as an electrical signal carried over a network such as the Internet).

Throughout this specification the term stick is used to refer to the items used as a substitute for flowers used in a real arrangement. Although they may actually be wooden sticks, it is not intended that they be limited to such. The sticks are intended to be long and comparatively thin rod-like members which generally represent the stem of a flower. Furthermore, the sticks may include additional parts for example to represent he head of the flower or any leaves. Of course, compared to real flowers, these would be reduced or omitted so as not to obscure the trainee's view of where the stick is inserted in the support structure. Furthermore, where the invention is applied to pictures such as on paper or on computer display, then the sticks will be lines corresponding to the stems, again possibly including some additional parts to represent some of the parts of the flower it is representing.

Whilst the sticks may be substantially rigid, they may also have a degree of flexibility preferably corresponding to that of the flower stem being simulated. In addition with a degree of flexibility, the sticks may additionally include weighting at one end to simulate the weight of the flower head and foliage and its affect on the bending of the flower. This flexibility and weighting may be simulated in images of the sticks by showing flexing of the sticks.

The sticks used are preferably coloured or patterned to differentiate between different flowers in an arrangement. Thus, different colours may be used to distinguish different types of flower, different properties of the same type of flower (e.g. different colours, different lengths, amount of leaves removed along the stem, whether they are still in bud or already blossomed and so on) or even different lengths of flower. In this way different coloured or patterned sticks may be used to differentiate such variants.

Additionally, the lengths of the sticks may be selected or variable to correspond directly to the lengths of the flowers they represent or as above to distinguish different types or variants of flowers.

In this specification reference is made to flower arrangements and arranging flowers. However, the present invention relates to the preparation of other sorts of arrangements which may not include flowers. For example, the present invention also relates to arrangements utilising non-flowered material such as twigs or leafy material etc.

### BRIEF DESCRIPTION OF THE DRAWINGS

In the attached drawings:

FIG. 1 shows an example of the display system of the present invention;

FIG. 2 shows the arrangement of FIG. 1 after further flower sticks have been inserted;

FIGS. 3A-3D show a series of stick models used to demonstrate the sequence of the steps in the development of an arrangement;

FIGS. 4A-4D show a series of images representing a real flower arrangement corresponding to FIGS. 3A-3D respectively;

FIGS. 5A-5D show a second example of a series of stick models;

FIGS. 6A-6D show a series of images representing a real flower arrangement corresponding to FIGS. 5A-5D respectively;

FIG. 7 shows a schematic representation of a system according to the present invention;

FIG. 8 shows an alternative system according to the present invention for connection to a remote server;

FIGS. 9A-9D shows an example of a series of steps in the generation of a user defined arrangement in accordance with the present invention; and

FIG. 10 shows in detailed an example of a practical embodiment of a computer based implementation of the present invention.

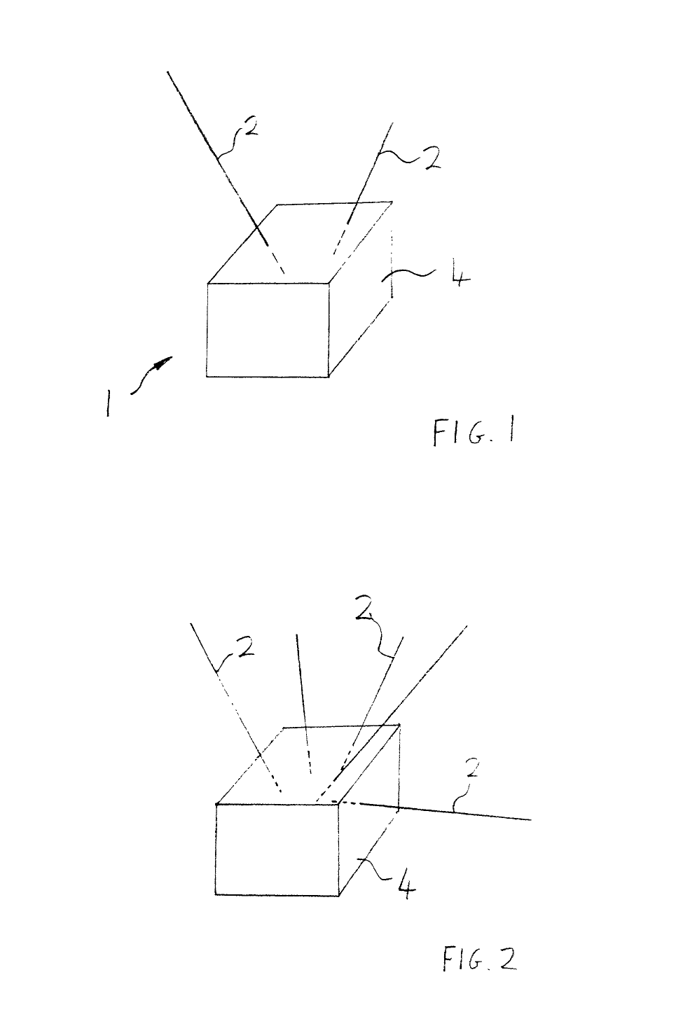

### DESCRIPTION OF PREFERRED EMBODIMENTS

The present invention will now be described in more detail by reference to specific examples.

As indicated above, an application of the present invention involves teaching a trainee how to prepare an arrangement in a classroom environment. In accordance with the present invention, this can be achieved using a model formed using sticks as shown in FIG. 1. When a trainer wants to teach a trainee how to prepare flower arrangements, they need to explain to the trainee how to place the flowers in the correct position and at the correct angle so that the overall affect of the flower arrangement is achieved. Where proper flowers are used, the leaves and flower heads obscure the view of the support structure preventing the trainee from seeing the precise way in which a flower is inserted into the support structure such as foam.

In the present invention the flowers are substituted at least partially with sticks which are intended to represent the stems of the flowers of a real arrangement. The trainer inserts a stick representing a flower into the foam at an angle and at a position corresponding to the angle and position which a flower should be inserted in a real arrangement. In this way, the trainee can see clearly where and at what angle the stick has been inserted. As the process continues, the trainer inserts more and more sticks to build up a representation of the complete arrangement. As the number of sticks increases, because the sticks are thin and uncluttered by leaves and flowers, the view of where each stick is being inserted and at what angle is still clear despite a large number of sticks having already been inserted. Clearly, in the latter stages of the preparation of a proper arrangement, the number of flowers already inserted would severely restrict the trainees view of where further flowers were being inserted. The trainer may also construct a corresponding arrangement contemporaneously so that the trainee can appreciate what a real arrangement looks like.

This method provides a considerable advantage over normal flower arrangement training techniques because it allows the trainee to see clearly throughout the process where the flowers should be inserted. However, the arrangement of sticks also gives a symbolic impression of what the finished arrangement might look like. Whilst it is important to explain to the trainee how to insert the flowers properly, it is also an important part of the learning process to be able see the arrangement build up. In this way, the student can get an appreciation of how the insertion of a flower at each stage of the production contributes to the appearance of the finished arrangement. The present invention provides the trainee with an appreciation of how the corresponding real arrangement would appear as it develops. This is clearly much better than trying to describe the positioning of each flower in isolation where the effect of that flower on the overall design cannot be appreciated.

The present invention is particularly advantageous when it comes to the preparation of images of each stage of the arrangement process such as where the training is to take place without a trainer actually having a demonstration example which they produce as the training proceeds. This system also allows the trainee to train without a trainer for example by providing the images in a reference book or using a software program or web browser to produce the images. Additionally, training can be carried out using videos or with simple picture cards, perhaps in conjunction with an audio tape. In effect, the present invention permits training to a high level such that trainees get a clear understanding of correct positioning of flowers even though they are not able to observe and examine closely a real arrangement.

The images produced may represent a single stage of the preparation of an arrangement such as the insertion of one flower. However, more than one image may be used to describe the introduction of one flower. For instance, the introduction of one flower may include an initial image showing how to introduce the flower, then another showing the position and angle of insertion from one viewpoint and then others showing the same from different viewpoints so as to give the trainee a clear impression of the arrangement and orientation of the stick and hence the flower. Where the images are displayed as a video or on a computer either as directly operating software or as a web browser page, the images may be formed into a animated sequence which may show the stick being inserted and perhaps also pan around the arrangement to give the trainee an even better impression of the positioning of the stick.

In order to enhance the trainee's appreciation of the appearance of an arrangement including real flowers, the trainer may produce contemporaneously an arrangement using real flowers corresponding to that which the stick model represents. In a similar way, where a trainee is being taught using images either on paper or on a screen, the trainee can be presented with pictures of both the arrangement using flowers and the arrangement using sticks to enhance the trainee's perception of the arrangement they are trying to produce. Furthermore, where the trainee is being presented with the images on a computer display, they may be presented initially with an image formed using real flowers but then given the option of seeing the foliage removed from those flowers so that only the sticks representing the stems remains so that the trainee can see how the sticks are inserted into the supporting foam. Equally, the user may be presented with the stick model first and then shown a view of the corresponding arrangement with realistic flowers.

Whilst the present invention is primarily described above in relation to the use of sticks to represent real flowers as a teaching aid in a classroom environment, the present invention is also applicable to uses where the sticks are used to represent flowers in pictures, videos or computer generated images. For example, the present invention can be applied to teaching aids either in conjunction with or in the absence of a teacher providing additional explanation.

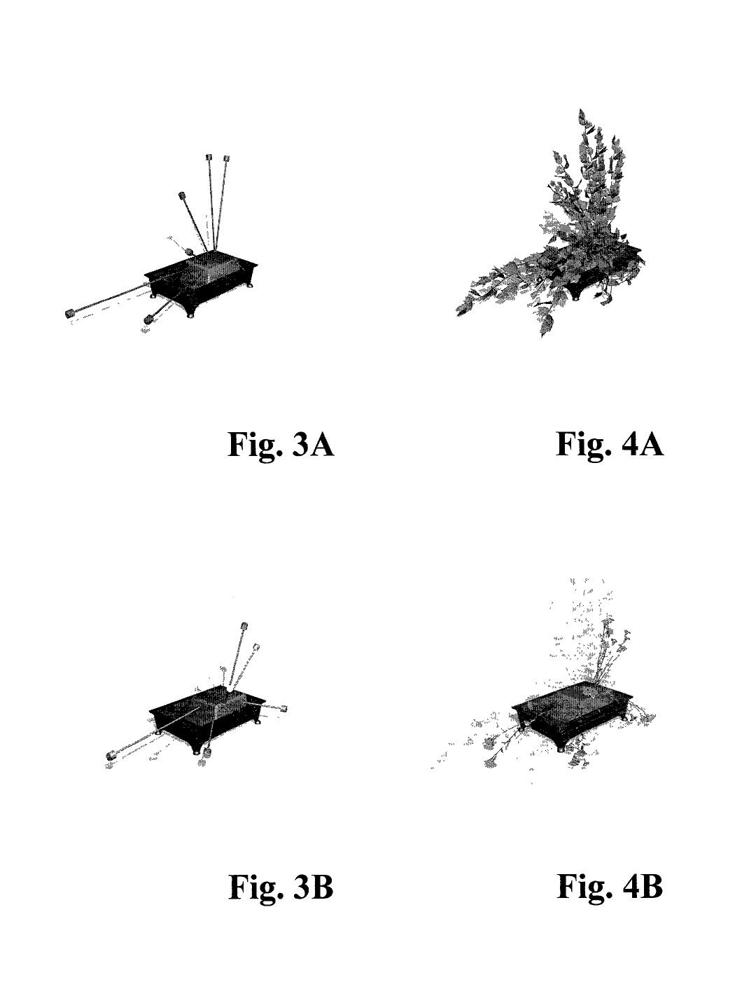

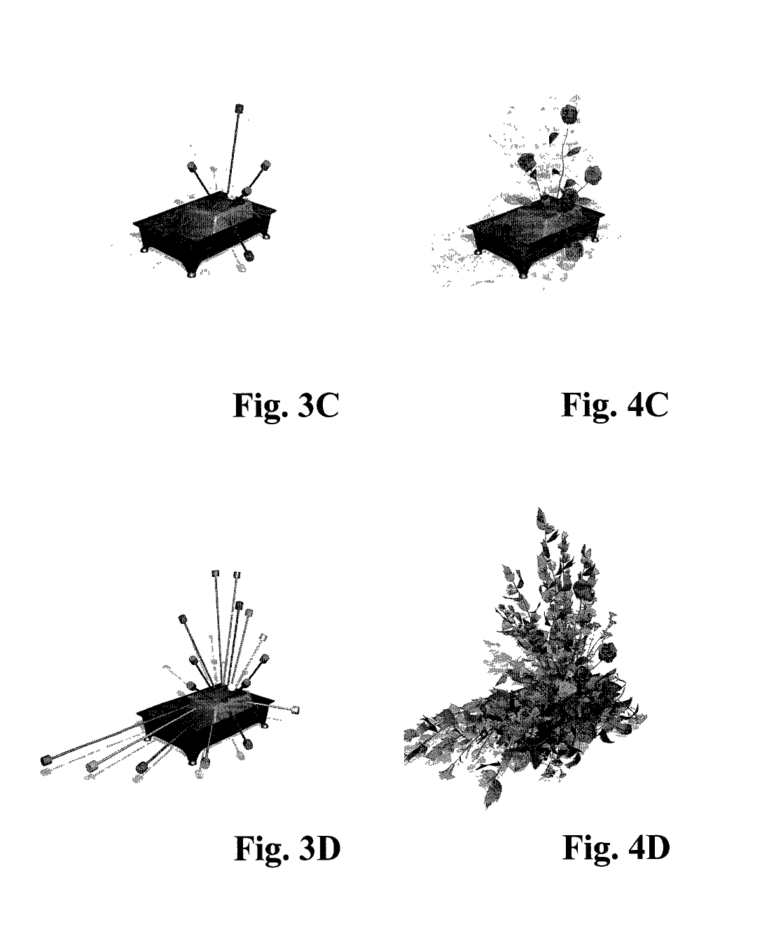

The present invention may be applied to a method of describing the sequential stages for producing specific flower arrangements in the manner of a recipe. In this way, the trainee can be led through each stage of the production of a flower arrangement showing how each flower which makes up the arrangement is prepared and inserted into the arrangement. Using the present invention, the user can be presented with images of the arrangement as it develops as well as a representative stick model in which the flowers are substituted by sticks. In this way, the user can see how the arrangement should appear in reality at each stage but they can also see how each flower is inserted into the arrangement by reference to the stick model. FIGS. 3A-3D and 4A-4D show representative series of images which may be presented to a trainee in order for them to see how an arrangement is produced. Each image pair in FIGS. 3 and 4 represents the arrangement after the insertion one type of flower. However, it is possible to provide a pair of images for the insertion of each flower or even several pairs for the insertion of each flower. Furthermore, an animated sequence could be produced by generating many images for each insertion.

In FIG. 3A, the stick model shows the position and angle at which the first type of flower should be inserted into the support structure to begin the arrangement. The corresponding image in FIG. 4A shows the arrangement as it should appear with real flowers. In this way, if the user is actually attempting to prepare an arrangement using the recipe detailed in the pictures then they can see how the arrangement should appear after the first flowers have been inserted. This helps to ensure that the appropriate length, body, appearance, etc. of stems is used as well as ensuring that the stems are inserted at the appropriate position and angle which can be seen from FIG. 3A.

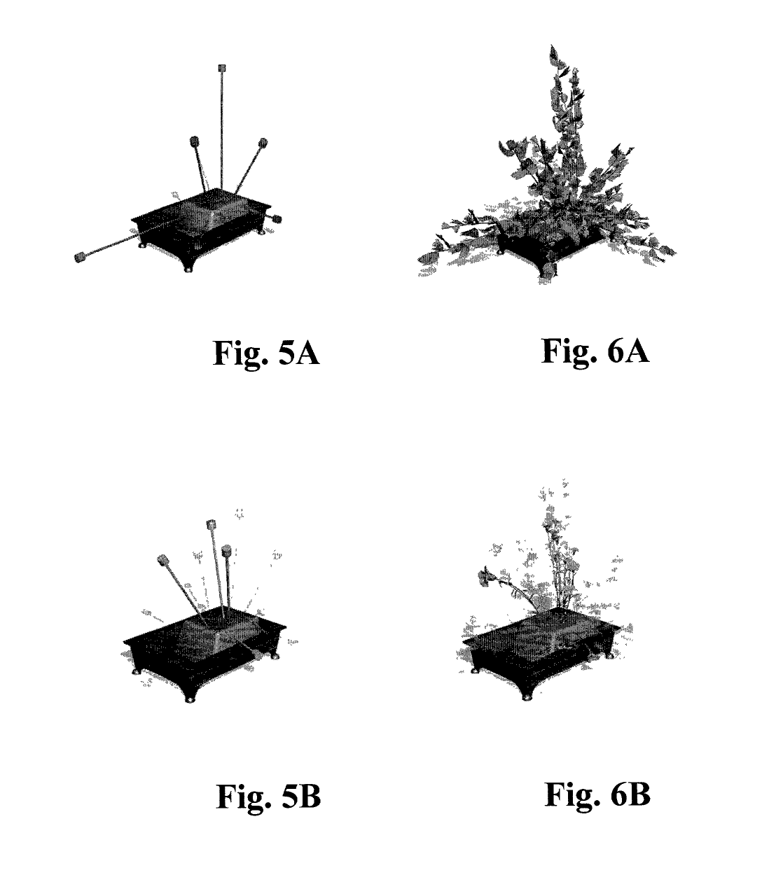

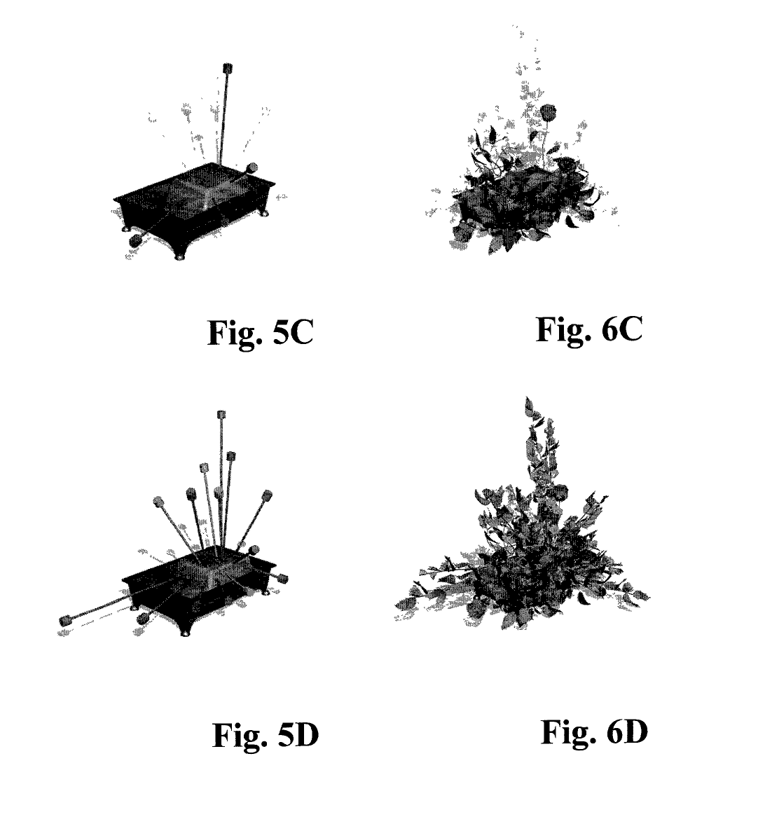

In FIGS. 3B and 4B, the next stage of the arrangement is shown. In these examples, the sticks and flowers in FIGS. 3A and 4B respectively are shown shadowed out to avoid any confusion with the new flowers to be inserted and to make the appreciation of position etc. of the new flowers easier. However, each image may show the previous flowers normally or not at all. By showing the previous flowers in shadow, the trainee can appreciate how each set of flowers interacts with the previous set of flowers while still being able to see clearly where the new set of flowers should be inserted and arranged. Similarly, in the stick model, this avoids any confusion between flowers that have already been inserted with flowers that are still to be inserted even though the sticks are preferably colour coded. In FIGS. 3C and 4C, the next stage of the production of the arrangement for inserting the third set of flowers is shown. Finally, in FIGS. 3D and 4D, the finished arrangement is shown both for the stick model and the real flower arrangement. This gives the trainee a final appreciation of how the finished arrangement should look and also how each of these sticks should be inserted. FIGS. 5A-5D and 6A-6D show a second example of a corresponding sequence of images similar to FIGS. 3 and 4.

As indicated above, the sequence of images described above, as shown in FIGS. 3, 4, 5 and 6, may be provided in the form of a book or a training manual in which the images are pre-printed. Alternatively, the images may be presented on a display, such as a computer screen. In this way, the user is still presented with a series of images representing the series of steps required to produce arrangements but the user is also provided with an additional degree of interactivity. In this way, the user may be provided with the ability to experiment with the arrangement in real time as well as additional features such as seeing an animated version of the flowers and/or sticks being inserted into the support structure to provide further clarification of where and how to insert each stem to form the arrangement. In addition, the user may also be provided with additional information on how to develop the arrangement by being able to receive spoken instructions played by the computer in addition to written information or instructions provided in conjunction with the images.

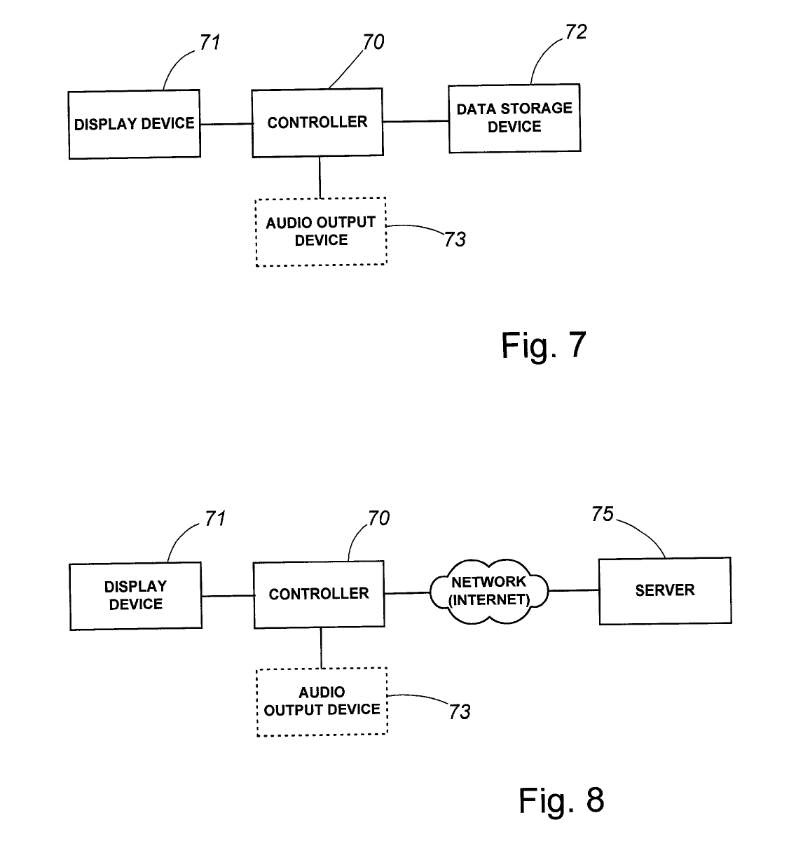

In order to implement such an embodiment of the present invention, the trainee or user can utilise a computer system for generating the images. As shown in the example of FIG. 7, such a system will comprise a controller 70 for processing and preparing the images for display on the display 71. As indicated above, the system may optionally be provided with means for providing audio information such as spoken instructions on how to develop an arrangement. This can be provided using the audio output device 73 however, the provision of an audio output is not essential to the present invention.

As shown in FIG. 7, the information required by the controller to generate the images for display is provided from a data input device 72. This device may take any number of forms but is preferably a high volume removal media storage device such as a CD ROM to provide the high volumes of data required to generate the images. This data storage may simply store a series of images which are displayed upon the display device 71. However, the information stored may also be in the form of data describing each of the objects to be displayed as well as additional position and orientation information for that object so that the controller can then generate the images required to produce the sequence of pictures. These objects may be the flowers in the realistic flower arrangement display, the sticks in the stick model as well as other objects such as the support structure and base etc. In this embodiment, the controller includes software or hardware means to utilise this object data to produce the appropriate images. Such software and hardware processing is well-known particularly for rendering of 3-D objects on a screen.

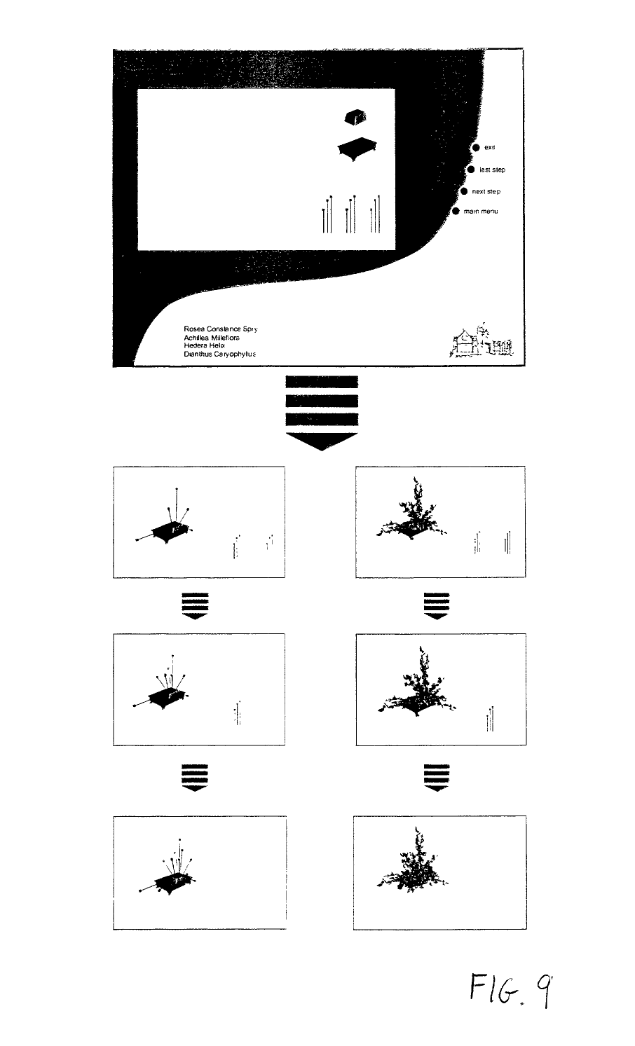

In FIG. 8, an alternative to the embodiment of FIG. 7 is shown. This embodiment similarly includes a controller 70, a display 71 and optionally a audio output device 73. However, rather than the data being provided from storage means provided with the computer system, the controller may obtain information over a network 75 such as the internet. In this way, the user instructs the controller to access the information stored at one or more remote servers 76.

The controller obtains information and presents the user with a choice of arrangements which they may wish to develop. The user can then select which arrangement they are interested in and the controller then obtains the information from the server via the network 75. In this embodiment, the controller may include software or hardware for producing images based on data downloaded from the server on the various objects and their position.

Alternatively, the controller may comprise relatively simple browser software such as Internet Explorer(TM) which simply accesses images at the server and downloads them as web pages (e.g. HTML) or the like. In this way, the server can prepare appropriate information for example the images shown in FIGS. 3A and 4A as web pages which are then downloaded by the controller via the network.

As a further alternative, the controller may include additional animation software for displaying movie files such as Quicktime VR (TM) files. In this way, the controller 70 can download the data for displaying such movie files for display using the users browser software and any additional animation software to display animated images.

In the above described embodiment, the user or trainee is simply presented with a sequence of images, either stills or animated, to demonstrate the stages of development of an arrangement. In a further alternative embodiment of the present invention, a user may be provided with a further option which allows them to design arrangements of their own or experiment with the predetermined arrangements described above. In this way, rather than the user being simply presented with a predetermined arrangement which is demonstrated to them step by step, the user may be presented with a menu of objects which they can then insert into a support structure to develop their own arrangement. This embodiment provides an advantage in that a user can develop an arrangement using the stick model to insert sticks into a support structure at angles and positions which they can clearly see. The computer system is then able to generate a representation of how the arrangements would appear if real flowers were being used. This allows the user to experiment and develop arrangements without actually using real flowers. This provides a clear advantage in that the cost of experimenting with real flowers is avoided and only after the user has developed an arrangement which they are happy with do they need to revert to using real flowers.

In this embodiment, the user requires a similar arrangement to that shown in FIG. 7. However, rather than loading data from a data input device 72, because the user is not following a predetermined recipe, then it is not necessary to store the information and image sequences required for demonstrating such a recipe. However, in order to generate the various components (or objects) of the arrangement, it will be necessary to provide the controller with information on each of the objects which will be available for manipulation by the user in designing an arrangement. For example, the controller might present the user with a menu of objects which they can use to produce an arrangement. This might include a selection of bases to allow different styles of arrangement. The user may also be presented with different designs of support structure, again according to the style and arrangement which they wish to develop. Of course, the user will need to be given a selection of flowers to choose from in order to construct their arrangement. Thus the controller is arranged to present a selection of sticks representing different types of flowers and possibly also different lengths of flower. The user can then select the various objects which can be used to form the arrangement from this menu to build up an arrangement of their own design.

Thus when a user wishes to design an arrangement, the controller begins by loading information which can be used to describe each of the objects available for the user to design with. The controller, which includes a user interface means such as a keyboard, mouse, track ball etc., allows the user to select a base and support structure to form the foundation of an arrangement. The controller then allows the user to select from an assortment of sticks representing different flowers and also for the user to select the length. This may be achieved by allowing the user to select from a displayed array of sticks presented on the display device or by allowing the user to select the size, length and any other characteristics of a flower from a list. Alternatively, the user may initially be presented with a selection of views of real flowers from which to make their choice. Only when they are designing do the flowers get displayed as sticks to allow for easy insertion and positioning of the sticks. Of course the controller may determine the users requirements in a variety of different ways still within the scope of the present invention.

The controller then determines at what position and orientation the user wishes to place the stick in the support structure using the user interface. Whilst the user is manipulating each object, the controller can display the stick model on the screen along with the object as it is manipulated according to the users instructions into its desired position. Furthermore, the controller may also control the display means to produce an image of the appearance of the finished flower arrangement corresponding to the stick model which the user has produced. The presentation of the real flower arrangement may be simultaneous to the stick model, for example in a side-by-side arrangement or the real flower arrangement may be displayed once the currently selected stick has been put in position in the support structure. Alternatively, the controller may provide the user with an option to toggle between a real flower display and the stick model.

The controller continues to develop the stick model based upon the users selections and arrangement until the user is happy with their arrangement. The user may then wish to record their arrangement or even produce a recipe along the lines of those described above to allow them to reproduce a corresponding real flower arrangement. Therefore, the controller may produce a series of printed images showing the various steps of the recipe for developing the arrangement designed by the user.

In the above embodiment, the arrangement is developed using objects selected and arranged by the user with the images being prepared by the controller 70. However, in an alternative arrangement, the controller may operate by obtaining the users selection of the type and other features of an object and then send that information to a remote server in an arrangement similar to FIG. 8. The server may then generate an image representing the users selection which is then sent back to the controller 70 via the network to be presented on the display 71. In this way, the complex software or hardware for developing complex 3-dimensional images is not needed in the controller 70. The controller 70 may be a simple terminal for example having a web browser or the like which acts as an input terminal to receive the users selection and a display. The information is then passed to the remote server 76 which may generates a display file such as a HTML file including the generated image of the arrangement with the selected object placed in the desired position. This HTML file is then sent back to the controller which simply presents the information on the display.

FIG. 9 shows a simple example of how an arrangement is developed using this interactive method. The user is initially presented with a selection of objects including flowers, a base and a support structure. At each stage the user is able to select a stick for insertion in the support structure and then control its position and orientation of insertion. This continues until the finished arrangement is derived.

A further embodiment of the present invention combines features of the previous two embodiments to provide a system in which a user is able to select a predetermined reference arrangement of flowers and then use the computer to develop their design with reference to the predetermined reference. Thus when the user begins, they select their reference arrangement which is then displayed on the screen. The displayed image may be one or both of a stick model and a real flower view. For example, the reference view could be displayed in a portion of the screen, like that shown in FIG. 9, with the arrangement being developed being shown in another part of the screen. This reference arrangement provides the user with a basis upon which they can develop their own arrangement.

Thus, the controller 70 produces the reference image as well as the image of the arrangement being developed. As above, the user is then able to manipulate the objects which make up an arrangement to develop their own arrangement. The user may be allowed complete freedom to design any arrangement, irrespective of the reference design, i.e. the reference is there literally as a visual check. Alternatively to provide a degree of assistance, the controller may restrict the design options available to the user by, for example, restricting the range of positions, size and types of flowers, etc. In one example, the controller may only allow flowers to be inserted at points corresponding to the reference arrangement but provide a degree of flexibility of the angle of insertion. Alternatively, the angle may be fixed but the position variable and so on. They are clearly a large number of variables in an arrangement which can be selectively fixed or restricted to within certain parameters in order to limit the variations in the design available to the user. In this way, the user is only able to introduce small changes or deviations from the reference design. This ensures that whilst the user is relatively free to develop a design, so that they do not end up deviating significantly from a certain type of design, e.g. a pedestal design, they are prevented from inserting flowers in positions or at angles which are clearly not appropriate for a given type of design.

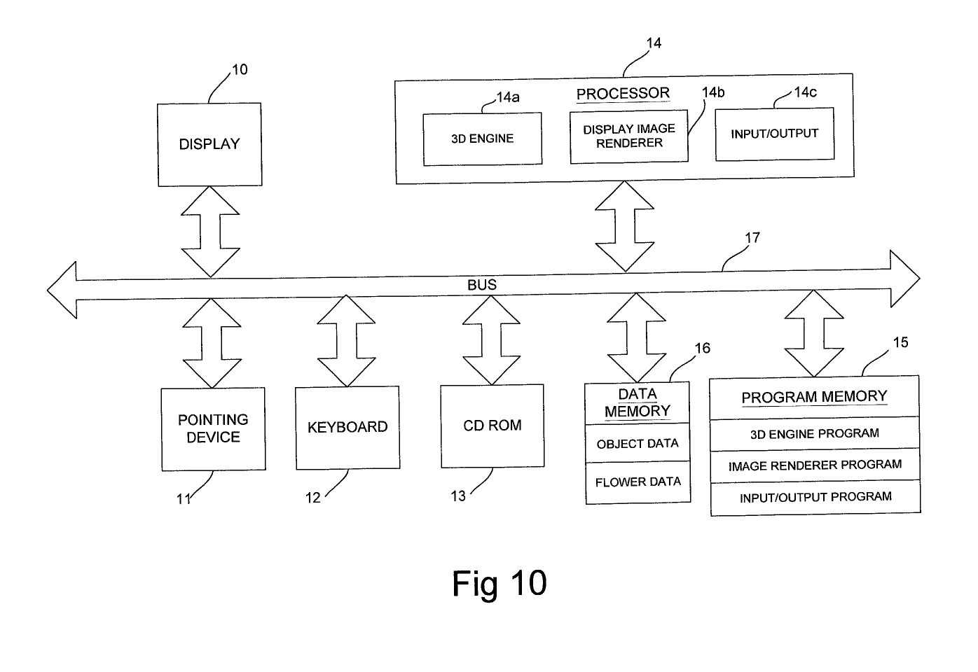

A practical construction of a computer based embodiment of the present invention will now be described with reference to FIG. 10. The construction comprises a processor 14 for executing program modules stored in a program memory 15. The processor is able to communicate with the program memory and other parts of the system using a bus 17. A user interface is provided in the form of a pointing device 11 such as a mouse or trackball and a keyboard 12. Images generated by the processor are sent to the display device 10 via the bus 17 to be displayed to a user. The system further includes data memory 16 for storing data relating to the objects to be generated by the controller. Whilst the data is stored in the program and data memories during operation, the data is stored permanently on a storage device, in this example a CD ROM 13, and loaded into the respective memories when required. The CD ROM stores the library of objects which may be made available to the user as well as the main program modules plus any additional modules which may be required.

The processor executes three main program modules as shown in FIG. 10. The first is a 3D graphics engine 14a for producing a data structure corresponding to a three dimensional representation of the stick model and of the corresponding flower arrangement. This three dimensional information data is then rendered into two dimensional image data 10, using the display image rendering program module 14b, for display on the display device. The various user inputs for controlling the functioning of the processor, the outputs to the display device 10 and interfacing with the CD ROM are controlled by the input/output program module 14c. This module communicates with the pointing device 11 and the keyboard 12 to provide the user input data to control the operation of the 3D engine.

In use, the processor initially loads up the basic program modules (the 3D engine program, the image renderer program and the input/output program) from the CD ROM into the program memory 15. The object data and flower data is also loaded into the data memory 16. The 3D engine 14a develops a three dimensional data representation of the stick model and the corresponding real flower view of the flower arrangement based upon the object and flower data. The renderer 14 uses the three dimensional data representation to generate the two dimensional image data which is sent to the display to be displayed to the user. The renderer can be arranged to produce data corresponding to an image of one or other of the three dimensional representations or both, e.g. in a side by side arrangement. Once the initial image is displayed, the processor then obtains user input, using the input/output program. This allows the instructions from the user to manipulate the objects shown on the display to be processed so that the 3D engine can modify the three dimensional data representations accordingly.

The 3D engine modifies both of the three dimensional data representations so that, whether the user moves a stick object in the stick model or a flower object in the flower model, both representations are modified correspondingly to represent the same arrangement n different ways. As indicated above, the renderer utilises the data of the three dimensional data representations to produce the two dimension images for display. Where only one of the representations is displayed, the user is provided with a means to toggle between which view they see. In response to such a toggle input, via the input/output program, the renderer produces a new image for display based on the alternative three dimensional representation data.

Although they are not described in detail here, the construction of the program modules referred to are well known, for example in the field of three dimensional graphics production.

Thus according to the present invention, a user is able to learn about predefined arrangements and follow a specified recipe for preparing such arrangements as well as being able to design and develop their own arrangements. However, the underlying benefit of all these arrangements is that a user is able to see how each stem is positioned in the support structure relative to all the other stems without their view being obscured by the actual foliage which would form the stem of a real flower. In addition, the present invention provides a model which, whilst not showing the actual flowers, allows the user to have an appreciation of what the finished arrangement will look like by providing an impression of the arrangement by virtue of the colour coding or other identification means of the sticks.

As indicated above, the term stick is used throughout the specification to refer to the object used in place of a real flower. In the embodiments of the invention relating to pictures or images generated on a computer screen or otherwise electronically, the sticks may be simply a line in the image but they may also include some or all of the foliage of a real flower. Clearly, to achieve the benefit of the present invention it is important that the part of the stick which is inserted into the support structure is not obscured by any foliage. Thus, if any foliage is shown at that end of the stick, it must be transparent or shadowed out so that the end of the stick and other sticks are clearly visible.

1. A method of trainer teaching a trainee how to produce a flower arrangement comprising:
inserting one or more sticks into a support structure at predetermined locations, each stick corresponding to the location and angle of insertion of a flower of the flower arrangement.

2. A method according to claim 1 wherein the sticks are inserted sequentially.

3. A method according to claim 1 wherein the sticks are colour and/or or patterned coded to represent different varieties or styles of flower in the arrangement.

4. A method according to claim 1 wherein the lengths of the sticks are chosen to represent the length of the flowers which they represent.

5. A method of training a trainee how to produce a flower arrangement comprising: presenting to the trainee a series of image sets, each image set comprising one or more images representing a stage in the process of preparing the flower arrangement, the images including one or more sticks positioned and arranged at angles corresponding to a flower in the flower arrangement.

6. A method according to claim 5 wherein the set of images includes a plurality of images and each image shows the same stage from at least one of a different position or different angle.

7. A method according to claim 5 wherein the set of images includes a plurality of images which when shown sequentially provide an animated view of the arrangement.

8. A method according to claim 7 wherein each image shows the same stage from at least one of a different position or different angle.

9. A method according to any one of claims 5 wherein at each stage additional sticks are shown.

10. A method according to any one of claims 5 wherein the sticks are colour coded to represent different types of flower in the arrangement.

11. A method according to any one of claims 5 wherein the lengths of the represent the length of the flowers which they represent.

12. A method of preparing a series of images representing the steps in the preparation of a flower arrangement comprising: producing each image to represent a stage in the preparation of the arrangement wherein the flowers in the arrangement are represented by sticks which are positioned and angled similarly to the flowers which they represent.

13. A kit of parts for use in teaching trainees how to produce a flower arrangement, the kit comprising:
at least one support structure into which a plurality of sticks can be inserted and retained at a variety of mutual angles and insertion depths, and
a plurality of generally elongate sticks for representing flowers in an arrangement, the sticks being substantially free of protuberances such the view of the support structure and the position and angle at which the sticks had previously been inserted into the block is not obscured.

14. A kit of parts according to claim 13 wherein the sticks are substantially rigid.

15. A kit of parts according to claim 13 wherein the sticks are flexible to represent the flexibility of a flower stem.

16. A kit of parts according to claim 13 wherein each stick is coloured in one more different colours.

17. A kit of parts according to any one of claims 13 wherein the sticks are provided in one or more different lengths.

18. A kit of parts according to any one of claims 13 wherein the support structure is a foam structure.

19. A kit of parts according to any one of claims 13 wherein the support structure is formed from chicken wire.

20. A device for generating images representing a flower arrangement, for display on a display device, the device comprising:
a controller arranged to generate one or more first images, each image showing a symbolic representation of a flower arrangement comprising a support structure and one or more generally elongate objects representing each flower, each object being devoid of foliage at least at one end.

21. A device according to claim 20 wherein the controller is arranged to receive user input information from a user interface and wherein the controller generates modified first images corresponding to said user input.

22. A device according to claim 21 wherein said user input information includes at least one of object selection, object properties and object position information.

23. A device according to any one of claims 20 further comprising a user interface for obtaining said user input information.

24. A device according to claim 23 wherein said user interface is connected to said controller over a network.

25. A device according to claim 23 further comprising a display for receiving and displaying images generated by said controller.

25. A device according to claim 25 wherein said display is connected to said controller over a network.

26. A device according to claim 20 wherein said control means generates each of said first images sequentially, each images representing a step towards a complete flower arrangement.

27. A device according to any one of claims 20 wherein said controller also produces one or more second images, each second image corresponding to one of said first images and showing a representation of the flower arrangement of the corresponding first image in which the flowers represented by objects are shown as flowers.

28. A device according to claim 27 wherein said each second image is displayed simultaneously with the corresponding first image.

29. A computerised teaching aid for teaching a trainee to produce a flower arrangement, comprising:
storage means for storing data on one or more flower arrangements and data on generally elongate objects corresponding to flowers and/or foliage used in the or each flower arrangement; and
a user interface for generating and outputting images of the or each flower arrangement and images of the generally elongate objects positioned in a support structure in positions corresponding to the positions of corresponding flowers and/or foliage in the or each flower arrangement.

30. A computerised teaching aid according to claim 29 wherein the user interface is adapted to receive user selection of generally elongate objects and position instructions, and to use the stored data to generate and output an image of the selected and positioned elongate objects and an image of the corresponding flowers and/or foliage correspondingly positioned for comparison.

31. A computerised teaching aid according to claim 29 wherein the user interface is adapted to generate and output a sequence of images of elongate objects positioned in a support structure and corresponding images of corresponding flowers and/or foliage in corresponding positions showing how a flower arrangement is constructed.

32. Processor readable and executable code for controlling a processor to carry out the method of any one of claims 1 to 12.

33. A carrier medium carrying the processor readable and executable code according to claim 32.
